(19) United States
(12) Patent Application Publication
(10) Pub. No.: US 2019/0375325 A1
(43) Pub. Date: Dec. 12, 2019

(54) SHIFTING AND TILTING DEVICE FOR TABLES IN MULTIPURPOSE VEHICLES

(71) Applicant: ST.LA. S.R.L., PONTEDERA (IT)

(72) Inventor: STEFANO ZAPPOLINI, PONTEDERA (IT)

(21) Appl. No.: 16/461,182

(22) PCT Filed: Nov. 17, 2017
(86) PCT No.: PCT/IB2017/057218

§ 371 Date: May 15, 2019

(30) Foreign Application Priority Data
Nov. 17, 2016 (IT) 102016000116214

(51) Int. Cl. B60N 3/00; A47B 13/08; A47B 5/04

(52) U.S. Cl. CPC B60N 3/001; B60P 3/36; A47B 5/04; A47B 13/088

(57) ABSTRACT

The device (1) for moving a supporting plane (2) between a raised position (H) and a lowered (L), and vice versa, comprises at least one vertical guide (3), in which is slidably engaged a slide (4) associated with the supporting plane (2). Between the vertical guide (3) and the slide (4) is interposed a cinematic lever (5), consisting of a first and a second lever (51, 52), compassed between two configurations, open (A) and closed (C), in correspondence of, respectively, said raised (H) and lowered (L) positions. The first and second levers (51, 52) are also interconnected by means of a gas spring (53), whose expansion push urges said levers (51, 52) to close further when the supporting plane (2) is in said lowered position (L), thus stabilizing it. By manually opening said levers (51, 52) beyond a dead point, the same push of the gas spring (53) tends to open them so as to automatically raise the supporting plane (2); the latter can also be tilted from a horizontal position to a vertical one by means of hinges (6).

### TECHNICAL FIELD

The invention fits in the technical field relating to the furniture of multi-purpose vehicles, equipped for recreational purposes or as mobile offices.

The type of vehicles to which is made reference is therefore that one of motorhomes, caravans, vanes, minibuses and the like.

### BACKGROUND ART

To make the most of the available space of these vehicles, it is common practice to use furniture components designed to vary the configuration of the passenger compartment according to the need of the moment, such as to obtain a so-called “dinette”, i.e. a table with its seating, or a bed area.

Transformation takes place by means of appropriate maneuvers to shift or lower certain elements, rotate others, bring more others to be used from a rest position, and so on.

In some configurations, they become part of the whole the same front seats of the vehicle, which can be rotated to the rear in order to become in fact armchairs and/or be reclined to be transformed into beds.

Among the elements that most frequently require to be moved to these vehicles are the tables, which are required at most generous dimensions when they are needed and at least cumbersome when they are not.

In the prior art solutions there are various types of mechanisms that govern the handling of said tables from the use position to the rest position, including the simplest ones just with hinge joints up to others more complex with sliding parts, levers and more yet.

The use position is often stabilized by means of folding legs or other devices to be put into operation to prevent accidental fall, which obviously can also be caused by an error or by a misguided operation, with possible fingers crushing or other injuries.

As easy to understand, table legs are very embarrassing in the cockpits of these vehicles, so the solutions that are lacking are particularly appreciated.

In most of these technical solutions, it is required to apply some manual force, both when is needed to lift something and when is needed put down the same thing or something else, since simply dropping by gravity often causes damage to the thing same or near ones, as well as possible dangers of impact with the operator.

Beyond the weight of the above said elements, which is contained for obvious reasons, maneuvers may be uncomfortable for the limited maneuvering spaces and/or the unnatural positions that the body needs to take.

It is also noted that for tables and other furnishing elements in some way comparable, the only two mentioned use and rest configurations are generally provided.

### SUMMARY OF INVENTION

The object of the present invention is therefore to propose a device for handling a piece of furniture in a multipurpose vehicle, structured in such a way that it can be raised and lowered, for arranging it in use or rest position, easier than the known systems.

Another object of the invention is to provide the two raised and lowered positions to be automatically stabilized without support legs, locking devices and the like to be arranged to work.

Yet another object of the invention is to contain the dimensions of the device and to arrange the relative organs in an optimum manner so as not to interfere with the movements of the occupants of the vehicle.

A further object of the invention is that the device may allow the associated furniture element to be provided with other configurations in addition to the classical use and rest ones, so as to obtain multifunctional functions.

Still another object of the invention is that the device is simple to realize, high in reliability and low cost.

These and other objects are fully achieved by means of a device for handling a furniture element in a multipurpose vehicle, with said furniture element comprising a supporting plane and with the above said device comprising:
at least a vertical guide, made integral with the structure of the mentioned vehicle, in which is slidably engaged at least one slide associated to said supporting plane and intended to enable the latter to a vertical excursion between a raised position and a lowered position, and vice versa;
at least one levers kinematism, comprising a first lever, articulated with one end to a fulcrum having a fixed position, and a second lever, articulated with one end to said slide, the same first and second levers being mutually articulated in correspondence of the respective free ends and intended to reach two peculiar configurations, open and closed, respectively in correspondence of the mentioned raised positions and lowered position of the above said supporting plane;
at least one elastic compression member, articulated with its ends to the mentioned first and second levers, according to a geometry such that when said levers kinematism is in the closed configuration the push action of said elastic member urges said levers in a direction tending to stabilize their closed configuration and the mentioned lowered position of the supporting plane, while, when said levers kinematism is moved by a predetermined amount from said closed configuration, the push action of the same elastic member urges said levers in a direction tending to determine the automatic lifting and the stabilization of said open configuration of the levers and the mentioned raised position of the same supporting plane.

### BRIEF DESCRIPTION OF DRAWINGS

The features of the invention will become apparent from the following description of a preferred embodiment of the device for handling a furniture element in a multipurpose vehicle, according to the object, in accordance with what is stated in the claims and with the aid of the attached drawings, in which:

FIG. 1 shows a perspective view of the device in question, associated with a supporting plane, with the latter in the raised position;

FIG. 2 shows a front view of what is shown in FIG. 1;

FIG. 3 shows a side view of FIG. 2, with the supporting plane in two positions;

FIG. 4 shows a view similar to FIG. 2, with the supporting plane lowered by the device;

FIG. 5 shows the corresponding side view of FIG. 4;

FIG. 6 shows a front view again, with the device as shown in FIG. 2 and the supporting plane vertically tilted;

FIG. 7 shows the corresponding side view of FIG. 6;

FIG. 8 shows, in perspective, an enlarged scale detail of a quadrilateral hinge with which the supporting plane is articulated to the device;

FIG. 9 shows a schematic side view of the hinge of FIG. 8 showing its operation.

### DESCRIPTION OF EMBODIMENTS

In the abovementioned figures, number 1 reference is made to the device for handling, object of the invention, as a whole.

Device 1 is associated with a furniture element 2 of a multipurpose vehicle (not shown) of the type mentioned above, or is equipped for recreational use or as a mobile office, such as a motorhome, a caravan, a van, a minibus or the like.

In the example shown in the figures, not limitative, the furniture element comprises a supporting plane 2, which essentially identifies a table, consisting of two portions 2A, 2B, articulated between them in the book type, so that they can be opened to lie side by side and coplanar one to the other or superimposable for reducing their dimensions (see FIGS. 3 and 5 in particular).

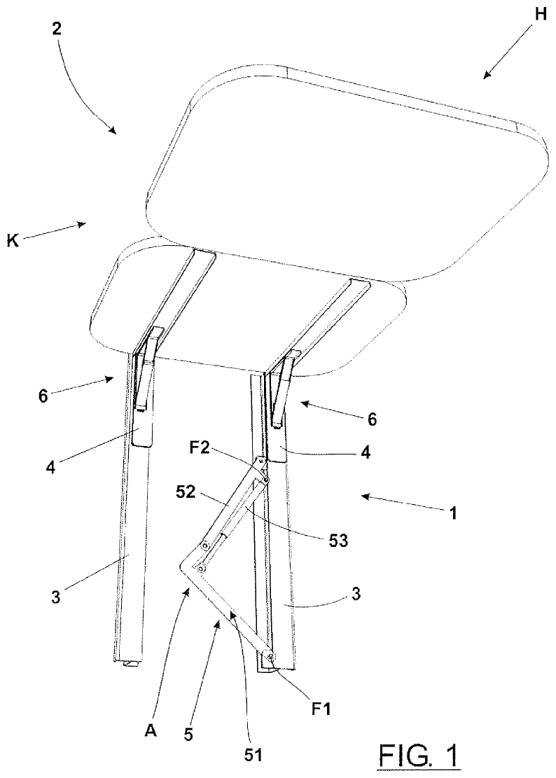

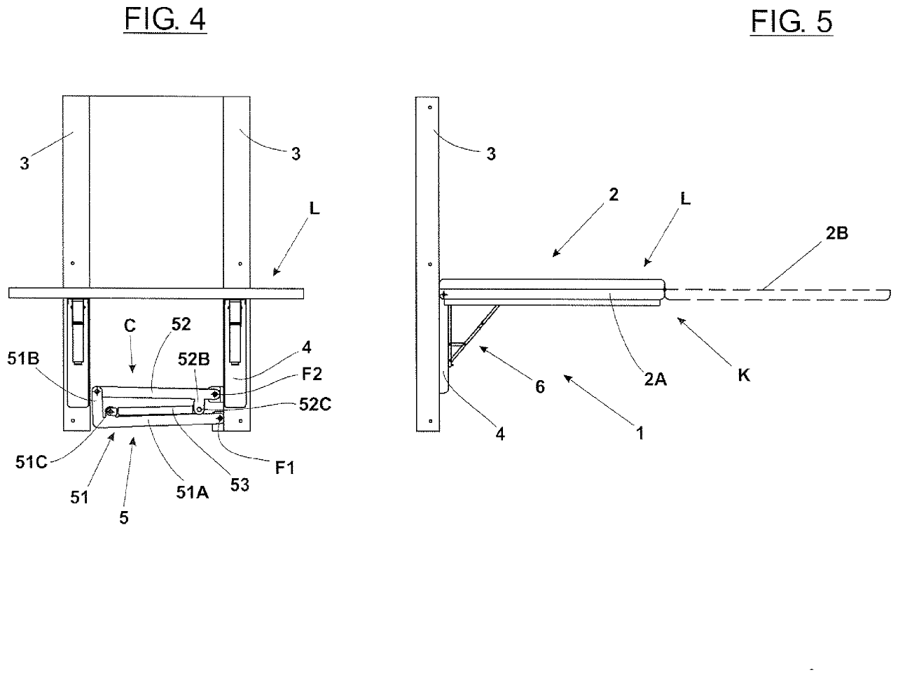

The device 1 comprises at least a vertical guide 3, integral with the structure of the said vehicle, in which is slidably engaged at least one slide 4 associated with said supporting plane 2 and designed to allow the latter to slide vertically between a raised position H (FIGS. 1, 2, 3) and a lowered L (FIGS. 4, 5), and vice versa.

In the embodiment illustrated there are provided two vertical guides 3, mutually parallel and spaced appropriately, and equal slides 4.

In device 1 there is provided at least one levers kinematism 5, comprising a first lever 51 articulated with one end to a fulcrum F1 having a fixed position, and a second lever 52 articulated with one end to one of the slides 4 in one fulcrum F2.

The fulcrum F1, in the example illustrated, is realized in a plate 55 integral to the lower end of one of the vertical guides 3, but alternatively the same plate 55 can be attached to the said vehicle structure.

The first and second levers 51, 52 are mutually articulated in correspondence of the respective free ends and may have two characteristic configurations, open A (FIGS. 1, 2, 6) and closed C (FIG. 4) respectively in correspondence of said raised H and lowered L positions of the supporting plane 2.

At least one elastic compression member 53, preferably consisting of a gas spring, is interposed between said first and second levers 51, 52.

The gas spring 53 is articulated with an end to the first lever 51 and with the remaining end to the second lever 52, according to a particular geometry better detailed below.

The first lever 51 is formed by two consecutive branches, first 51A and second 51B, arranged in square, and the eyelet 51C provided for the first articulation of the gas spring 53 is located near the corner between said branches 51A, 51B.

The second lever 52 has substantially rectilinear shape, with a length similar to that of the first branch 51A of said first lever 51; the relative eyelet 52C provided thereon for the second articulation of the gas spring 53 is located in an appendix 52B protruding laterally from the same second lever 52 near the fulcrum F2 according to which the latter is articulated to said slide 4.

In said closed configuration C, the first lever 51 is provided with its first branch 51A substantially orthogonal to the vertical rail 3, while the second lever 52 is substantially parallel to the same first branch 51A (FIG. 4).

The gas spring 53 is in the state of minimum extension, inclined so that the axial push provided by it has a force component tending to maintain said parallelism between the same levers 51, 52 and to stabilize its closed configuration C and, consequently, said lowered position L of the supporting plane 2.

By manually acting on the support plane 2 with an upward push, it is impressed a sliding movement to the slides 4 and therefore to the levers 51, 52 such that it determines the passing of a dead spot beyond which the expansion push of the gas spring 53 is oriented in a direction tending to open the same levers 51, 52 by increasing the angle formed by the same, thus causing the automatic lifting of the supporting plane 2.

At least one of the above-mentioned vertical guides 3 is provided with a stroke end (not shown in detail) for intercepting the corresponding slide 4 when the raised position H of the supporting plane 2 is reached, also defining the maximum opening angle between the said first and second levers 51, 52 arranged in their open configuration A.

In this latter condition, said first and second levers 51, 52 are almost orthogonal to each other, while the gas spring 53 is almost at its maximum extension, inclined so that its axial push has a force component which tends to increase the angle formed by the same levers 51, 52.

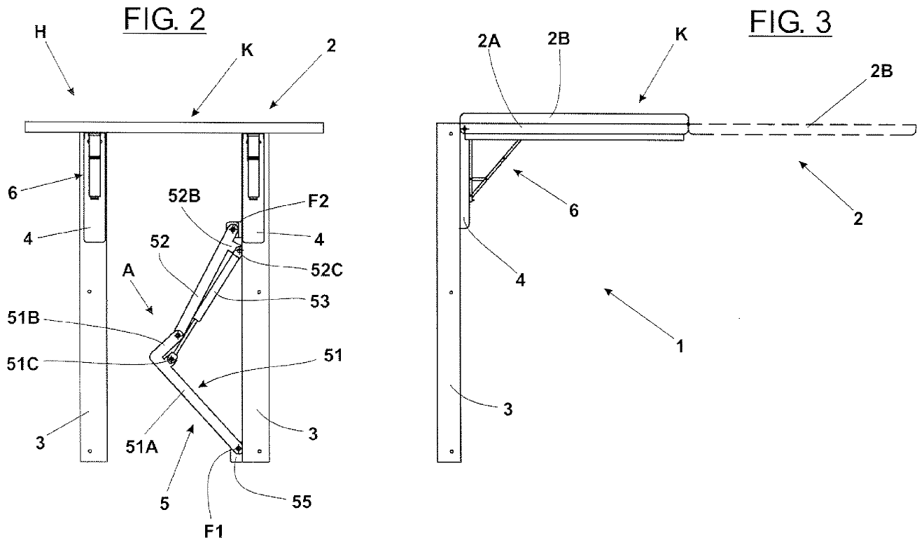

In the preferred embodiment of the figures, the second lever 52 is arranged to form, with the first branch 51A of the first lever 51, an angle slightly greater than 90° (see particularly FIG. 2).

With the end stop intercepted by the slide 4, the open configuration A of the levers 51, 52 and the raised position H of the supporting plane 22 is stabilized.

To prevent the supporting plane 2 being lowered as a result of a load higher than the resistance provided by the gas spring 53, a mechanical member may be advantageously provided for locking said raised position H.

Said member, not illustrated as of known art, can be, for example, a manually actionable latch for locking/unlocking the sliding of slide 4, or a harpoon that automatically snaps into the lock position when said raised position H is reached, to be released later by manual action.

To bring back the supporting plane 2 to the lowered position L, it is necessary to unlock said mechanical locking member, if present, so it is possible to act directly on the supporting plane 2 with a downward push, winning the elastic spring reaction of the gas spring 53.

Upon reaching the described closed configuration C of the levers 51, 52, beyond its dead point, the supporting plane 2 remains stationary in its lowered position L (FIG. 4).

For some applications, the supporting plane 2 in its lowered position L (FIGS. 3, 4) has an operational function; in fact, it can advantageously constitute an extension of the seating plan of a sofa or a seat, facilitating the conversion into bed of the same.

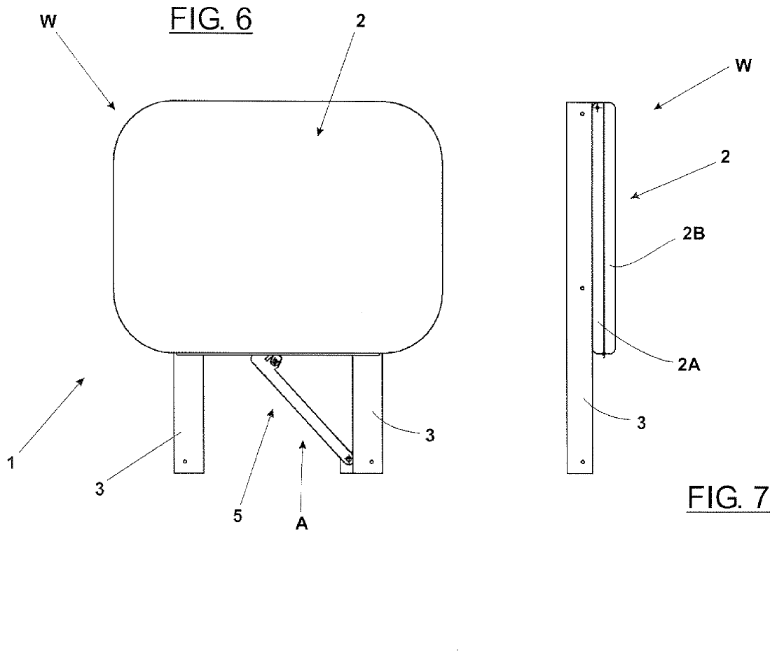

The supporting plane 2 illustrated is advantageously associated with the two slides 4 with the interposition of corresponding quadrilateral hinges 6 with horizontal axis, able to define for the same supporting plane 2 two positions, respectively horizontal working K (FIGS. 1 to 5) and vertical resting W (FIGS. 6 and 7).

Each hinge 6 comprises two wings 61, 62, of which the first 61 integral with the respective said slide 4 and the second 62 integral with said supporting plane 2, in this case to the first portion 2A of the latter.

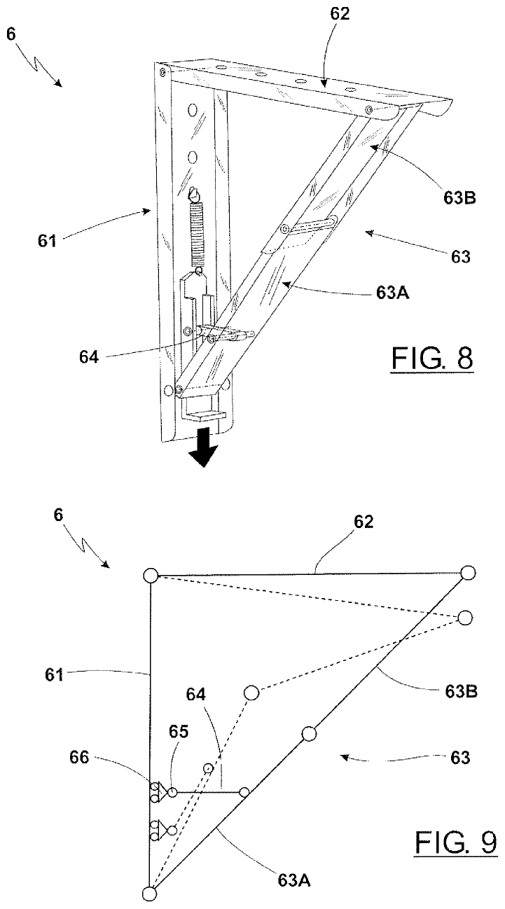

The wings 61, 62 are interconnected by a diagonal strut 63, articulated in two consecutive pieces 63A, 63B, which are substantially aligned to said horizontal working position K (FIGS. 1, 3, 5, 8) and folded one onto the other in the vertical resting position W.

In the hinge 6 is also provided a stabilizing strut 64 hinged to said diagonal strut 63 and further bonded to the first wing 61 by means of a joint 65 associated with a carriage 66, with the latter being able to slide parallel to the same first wing 61 (see, in particular, FIG. 9).

The stabilizing strut 64 is substantially perpendicular to the first wing 61 in correspondence of said horizontal working position K of the supporting plane 2 so as to block the alignment of the diagonal strut 63 and prevent it from rotating downwardly from the supporting plane 2.

To achieve this rotation, it is sufficient to manually push the diagonal strut 63 of each hinge 6 until the respective stabilizing struts 64 move from their previous position.

From the foregoing, they bring out the peculiar features of the device proposed by the present invention, which by means of its original conformation, allows to most automatically raise the table or the corresponding furnishing element, and lower it by means of simple maneuvers and limited efforts, without the risk of accidental falls and accidents.

In particular, as with respect to various known solutions, it is not necessary support legs, locking devices and the like to be provided for working, therefore, except of further unwanted drawbacks, a significant acceleration of the maneuvers is achieved.

The device, in the preferred illustrated and described embodiment, has very small dimensions, all of which can be attached to the structure of the vehicle, such as a side panel, with no obstruction elements for the legs of the occupants.

The double stabilization of the table both as raised and as lowered, makes it also possible to exploit this latter position, as specified in the previous description.

Another advantageous aspect comes from the constructive simplicity of the device, which is why it is reliable and cost-effective.

It is understood however that what has been described above has value of example and not of limitation, and therefore any detail variations which may be necessary in performing the phases described, for technical and/or functional reasons, are considered as from now on within the same protective scope defined by the following claims.

1-7. (canceled)

8. A device for handling a furniture element in a multipurpose vehicle, with the furniture element comprising a supporting plane, comprising:
at least one vertical guide made integral with a structure of the vehicle, slidably engaged at least one slide associated to the supporting plane so as to enable the supporting plane to achieve a vertical excursion between a raised position and a lowered position, and vice versa;
at least one levers kinematism including a first lever articulated with one end to a fulcrum having a fixed position, and a second lever articulated with one end to the slide, the first and second levers being mutually articulated in correspondence of respective free ends and intended to reach two configurations including an open configuration and a closed configuration, respectively, in correspondence of the raised position and lowered position of the supporting plane;
at least one elastic compression member, articulated with its ends to the and second levers, according to a geometry such that when the levers kinematism is in the closed configuration, the push action of the elastic member urges the levers in a direction tending to stabilize their closed configuration and the lowered position of the supporting plane, while, hen the levers kinematism is moved by a predetermined amount the closed configuration, the push action of the elastic member urges the levers in a direction tending to determine an automatic lifting and stabilization of the open configuration of the levers and the raised position of the supporting plane.

9. The device according to claim 8, wherein the first lever has a square angled configuration and an eyelet is provided on the first lever for a first articulation of the elastic compression member and is located close to a corner formed by two branches of the first lever, wherein the second lever has a substantially rectilinear shape, with a length similar to that of the first branch of the first lever, and a corresponding eyelet is provided on the second lever for a second articulation of the elastic member and is located in an appendix projecting laterally from the second lever and close to the fulcrum according to which the latter is articulated to the slide, in that, in the closed configuration, the first lever is arranged with its first branch substantially orthogonal to the vertical guide, the second lever is substantially parallel to the first branch, and the elastic member is in a condition of minimum extension, inclined so that an axial push action of the elastic member has a force component tending to keep a parallelism between the first and second levers, so that a displacement imparted to the first and second levers must determine an overcoming of a dead point, beyond which the elastic push force is able to make the first and second levers open as a compass, and in that, in the open configuration, the first and second levers are mutually almost orthogonal and the elastic member is in a condition next to a maximum extension, inclined so that an axial push action of the elastic member has a force component tending to increase the angle formed by the levers.

10. The device according to claim 8, wherein the elastic compression member is a gas spring.

11. The device according to claim 8, wherein the vertical guide is provided with an end stop arranged to intercept the slide when the raised position of the supporting plane is reached, so as to define a maximum opening angle between the first and second levers arranged in their open configuration.

12. The device according to claim 8, further comprising means for locking the raised position of the supporting plane.

13. The device according to claim 8, wherein, between the slide and the supporting plane, there is interposed at least one articulated quadrilateral hinge with a horizontal axis, capable of defining for the supporting plane two positions including a horizontal working position and vertical resting position, respectively, with the hinge including two wings, of which a first wing is integral with the slide and a second wing is integral to the supporting plane, and interconnected by a diagonal strut articulated in two consecutive parts that are substantially aligned in correspondence to the horizontal working position and folded one over the other in the vertical resting position, wherein the hinge is provided with a stabilizing strut, hinged to the diagonal strut and further constrained to the first wing by means of a joint associated to a carriage and arranged to slide parallel to the first wing), with the stabilizing strut provided to be substantially perpendicular to the first wing in correspondence of the horizontal working position. of the supporting plane, so as to block the aligned configuration of the diagonal strut and prevent rotation of the supporting plane.

14. The device according to claim 8, wherein the supporting plane is formed by two consecutive portions mutually articulated as a book, arranged side by side and coplanar in correspondence of a first configuration and folded one on the other in a second configuration.
